(19) United States
(12) Patent Application Publication
(10) Pub. No.: US 2010/0223935 A1
(43) Pub. Date: Sep. 9, 2010

(54) APPARATUS AND METHODS FOR FREEZING TISSUE SAMPLES FOR SECTIONING

(76) Inventor: Thomas M. Donndelinger, Nampa, ID (US)

Correspondence Address: KIRTON AND MCCONKIE, 60 EAST SOUTH TEMPLE,, SUITE 1800, SALT LAKE CITY, UT, 84111, US

(21) Appl. No.: 12/717,250

(22) Filed: Mar. 4, 2010

Related U.S. Application Data
(60) Provisional application No. 61/158,361, filed on Mar. 7, 2009.

(51) Int. Cl. F25B 19/00; B25B 1/00

(52) U.S. Cl. 62/51.1; 269/7

(57) ABSTRACT

Apparatus and methods for freezing a tissue sample in preparation of sectioning. Generally, the apparatus comprises a chuck and a tissue heat sink that are adapted to rapidly freeze a tissue sample before being sectioned in a cryostat. While the chuck and heat sink may be made of any suitable material, in some cases, the chuck and heat sink include copper, a copper alloy, bronze, or a bronze alloy. To keep the chuck and heat sink from tarnishing, they can be covered with a non-tarnishing coating material, such as tetrafluoroethylene. Additionally, in order to secure the tissue sample that is embedded in a cutting medium to the chuck, the chuck preferably includes one or more dovetail-shaped apertures, such as a dovetail-shaped groove.

### CROSS REFERENCE TO RELATED APPLICATION

This application claims the benefit of U.S. Provisional Application No. 61/158,361, filed Mar. 7, 2009.

### BACKGROUND OF THE INVENTION

This disclosure relates to apparatus and methods for freezing tissue samples. More particularly, this disclosure discusses a cryostat chuck and tissue heat sink that are adapted to rapidly freeze tissue samples in order to prepare the samples for precise sectioning with a cryostat.

Tissue samples may include one or more cells, tissues, organs, or other materials obtained from an organism, as well as the entire organism or a portion thereof. In order to prepare a tissue sample for histological analysis with a microscope, the tissue sample is often sliced into thin sections that are mounted on microscope slides. To cut the tissue sample to a desired thickness, the sample is generally frozen, or “vitrified,” and sliced with a cryostat. To freeze the sample, the sample is typically placed in a cutting medium on a pre-chilled tissue holder made from stainless steel or another similar metal. The tissue sample and cutting medium are then sandwiched between the tissue holder and another pre-chilled object, often referred to as a heat sink, which speeds the rate at which the sample is frozen. Once the tissue sample is frozen, the heat sink is removed from the sample and the sample, which remains anchored to the tissue holder, is placed in the cryostat for cutting.

A cryostat is a refrigerated device, which cools a cutting instrument, known as a microtome, to temperatures that are typically between about minus 20 and about minus 30 degrees Celsius. Within the cryostat, the microtome is used much like deli slicer to section the tissue into precisely measured slices that are as thin as about 1 micrometer and as thick as about 30 micrometers. Typically, however, the microtome is used to slice tissue samples into sections that are between about 5 and about 7 micrometers thick.

Cryostats can be used to slice tissue samples that have been prepared in variety of methods. In one example of a sectioning technique, a cryostat is used to section a tissue sample that has been fixed in a relatively time consuming tissue fixation process. In this example, the tissue sample is generally fixed with formalin, stained with a tissue stain, and then embedded with paraffin wax. In another example of a sectioning technique, a cryostat is used to section tissue sample before the sample is stained. In this sectioning technique, referred to as frozen sectioning, the tissue sample is rapidly frozen in the cutting medium and sectioned before being stained and/or analyzed.

This entire frozen sectioning technique, including the slicing, mounting, staining, and analysis of the tissue sample, is often accomplished in a period of time as short as 10 to 20 minutes. As a result, this frozen sectioning technique is often used during surgical procedures to render rapid interpretation of tissue samples that are excised from a patient so as to allow a surgeon to make informed decisions on how to best proceed with the operation.

Because this frozen sectioning technique is often performed during surgery, it is critical that the frozen sectioning technique be performed as quickly as possible. In some cases, however, the rate at which the tissue sample can be frozen to the tissue holder acts as a rate limiting step. Additionally, while it is important that such a technique be performed as accurately and precisely as possible, in some cases, the results are flawed because the vitrified tissue sample moves on or breaks from the tissue holder during sectioning.

Thus, while techniques currently exist that are used to slice tissue samples in preparation of histological analysis, challenges still exist, including those listed above. Accordingly, it would be an improvement in the art to augment or even replace current techniques and apparatus with other techniques and apparatus that speed tissue freezing times and keep the tissue sample spatially fixed to the tissue holder during sectioning.

### BRIEF SUMMARY OF THE INVENTION

The invention is drawn to apparatus and methods for freezing a tissue sample. More specifically this disclosure discusses a cryostat chuck and a tissue heat sink that are adapted to rapidly freeze a tissue sample embedded in a cutting medium. Moreover, while the heat sink is adapted to be easily removed from the frozen tissue sample and cutting medium, the chuck is adapted to hold the tissue sample in place during sectioning.

In some cases, in order to ensure that the spatial relationship between the tissue sample and the chuck remains unchanged during sectioning, the chuck comprises one or more dovetail-shaped grooves. For instance, the chuck can comprise a plurality of intersecting dovetail shaped grooves that secure the cutting medium and tissue sample to the chuck.

While the chuck and heat sink may be made of any suitable material, in some cases, the chuck and heat sink are made of copper, a copper alloy, bronze, or a bronze alloy. Because copper, bronze, and certain copper and bronze alloys have relatively high specific heats, such materials may be able to remove heat from a tissue sample better than other materials, such as stainless steel and aluminum, which are conventionally used to make cryostat tissue holders.

Where the chuck or heat sink comprise a tarnishing material, such as copper, the chuck and/or heat sink is preferably coated with a non-tarnishing material, such as polytetrafluoroethylene (PTFE or TEFLON®), stainless steel, chrome, etc. Indeed, in some preferred instances, at least a portion of the chuck and the heat sink are coated with polytetrafluoroethylene.

These features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained and will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a side-plan view of a representative embodiment of a cryostat chuck;

FIG. 2 illustrates a top-plan view of the cryostat chuck shown in FIG. 1;

FIG. 3 illustrates a bottom-plan view of the cryostat chuck shown in FIG. 1;

FIG. 4 illustrates a side-plan view of a representative embodiments of a tissue heat sink;

FIG. 5 illustrates bottom-plan view of the tissue heat sink illustrated in FIG. 4; and

FIG. 6 illustrates a side-plan view of a representative embodiment of the invention in which a tissue sample is being frozen between the chuck and heat sink.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as non-limiting examples of suitable apparatus (e.g., cryostat chucks and heat sinks), materials, processes, methods, components, characteristics, etc., to provide a thorough understanding of embodiments of the invention. One skilled in the relevant art will recognize, however, that the invention may be practiced without one or more of the specific details or methods, or with other methods, components, characteristics, materials, and so forth. In other instances, well-known structures, materials, or operations are not shown or described in detail to avoid obscuring aspects of the invention.

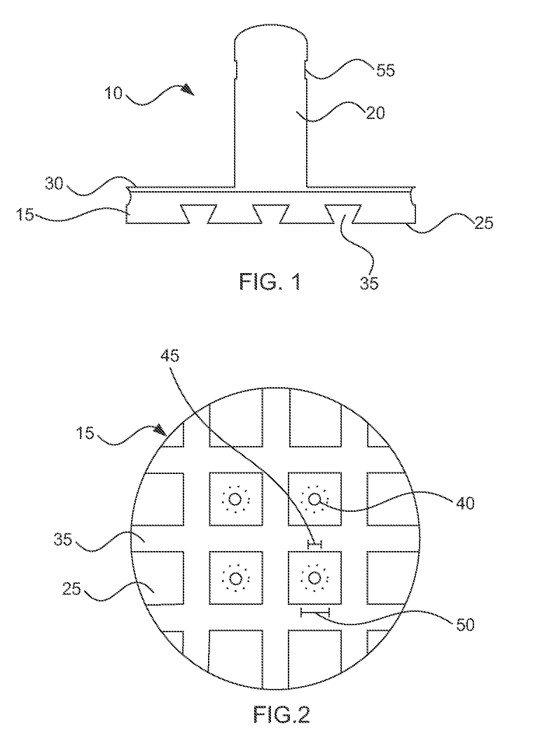

The embodiments of the present invention will be best understood by reference to the drawings, wherein like parts are designated by like numerals throughout. It will be readily understood that the components of the present invention, as generally described and illustrated in the Figures herein, could be arranged and designed in a wide variety of different configurations. Thus, the following more detailed description of the embodiments of the cryostat chuck and tissue heat sink represented in FIGS. 1 through 6, is not intended to limit the scope of the invention, as claimed, but is merely representative of the embodiments of the invention.

The present invention is drawn to apparatus and methods for freezing tissue samples. More specifically, this disclosure discusses a cryostat chuck and a tissue heat sink for quickly freezing tissue samples in order to prepare the samples for sectioning with a cryostat. In order to provide a better understanding of the cryostat chuck and the tissue heat sink, each is discussed below in more detail.

In some embodiments, the described apparatus and methods for freezing tissue samples include a cryostat chuck. Generally, the cryostat chuck acts as an interface between a frozen tissue sample embedded in a cutting material, such as an optimum cutting temperature (“OCT”) compound, and a cryostat. In addition to retaining the frozen tissue sample with a specific special relation to the chuck and connecting the sample to the cryostat, the chuck acts to freeze the tissue sample and to keep the tissue sample frozen during sectioning. Accordingly, the chuck can have any component or characteristic that allows it to perform these stated purposes. By way of example, FIG. 1 illustrates a representative embodiment in which the chuck 10 comprises a specimen plate 15 and means for coupling the chuck 10 with a cryostat (e.g., a stem 20).

Referring now to the specimen plate, the specimen plate may have any characteristic that allows a tissue sample embedded in a cutting medium to be secured to the chuck in a manner that maintains the tissue sample's special relationship to the chuck while the tissue sample is being sectioned. In example, the specimen plate can be any suitable shape, including, but not limited to, being substantially circular, square, triangular, polygonal, irregular, etc. In another example, the specimen plate can be any suitable size (e.g., have any suitable width, length, diameter, thickness, etc.).

The specimen plate can further comprise any component that allows the chuck to be used as intended. By way of illustration, FIG. 1 shows an embodiment in which the specimen plate 15 comprises a front surface 25, a rear surface 30, and means for securing the tissue sample and cutting medium to the specimen plate (e.g., dovetail grooves 35).

The means for securing the tissue sample and cutting medium to the specimen plate may comprise any component or characteristic that allows the cutting medium to be secured to the chuck in a manner that prevents the tissue sample from moving with respect to the chuck's front surface while the tissue sample is being sectioned. Some examples of suitable securing means comprise one or more dovetail-shaped apertures, corrugations, grooves, holes, protuberances, or other fixtures disposed on the chuck to which the cutting medium binds when frozen to the front surface.

In some presently preferred embodiments, however, the securing means comprises one or more dovetail-shaped apertures. As used herein, the term dovetail-shaped aperture, and variations thereof, may refer to any opening that broadens from the specimen plate's front surface as the opening extends towards the plate's rear surface. This dovetail shape of the apertures allows the cutting medium to enter the apertures before freezing and then frictionally secures the medium in place once the medium is frozen.

Some non-limiting examples of dovetail-shaped apertures comprise dovetail-shaped grooves, dovetail-shaped holes, and/or any other suitable openings that flare as the openings extend from the specimen plate's front surface towards the plate's rear surface. By way of illustration, FIG. 1 shows an embodiment in which the securing means comprises a plurality of dovetail-shaped grooves 35. In an another illustration, FIG. 2 shows a face view of a representative embodiment of the specimen plate 15 in which the dovetail-shaped aperture comprise at least one dovetail-shaped hole 40. Specifically, FIG. 2 shows the dovetail-shaped hole 40 comprises a first diameter 45 and a second, wider diameter 50 disposed within the specimen plate (as shown by dotted lines).

Where the securing means comprises a plurality of dovetail-shaped grooves, the grooves may have any relationship to each other that allows them to secure the frozen cutting medium to the specimen plate. For example, the grooves can run parallel to each other (e.g., as rings, straight lines, as wavy lines, etc.), intersect each other perpendicularly, intersect each other diagonally, or otherwise be patterned in the specimen plate. By way of illustration, FIG. 2 shows an embodiment in which a plurality of substantially straight dovetail-shaped grooves 35 intersect each other perpendicularly.

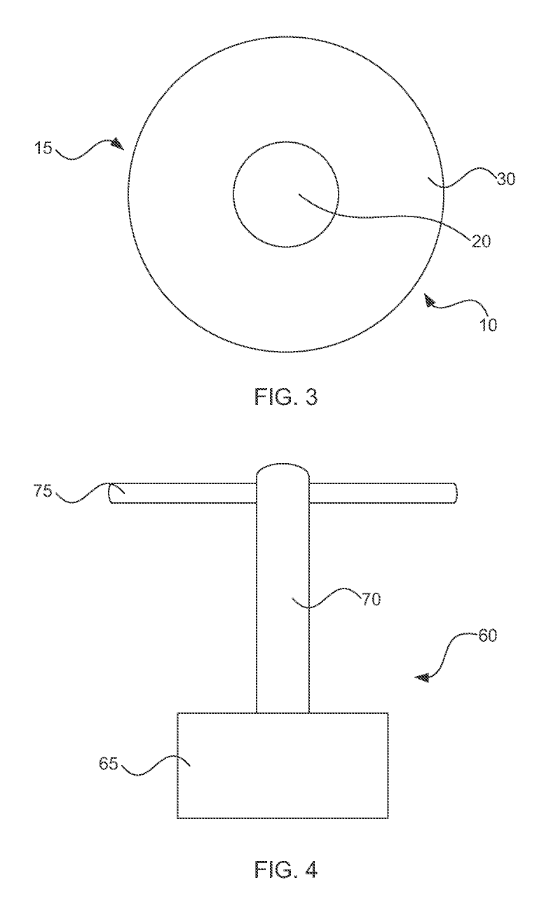

With respect to the means for coupling the chuck 10 with the cryostat, the chuck may comprise any component or characteristic that allows it to selectively couple the specimen plate to any suitable cryostat (not shown) in a manner that allows the cryostat to section the tissue sample. Some non-limiting examples of suitable coupling means comprise a stem, a female mating component (e.g., a flange defining a recess), and/or another component that is otherwise adapted to selectively and releasably couple to the cryostat. For instance, FIG. 2 and FIG. 3, which shows a bottom-plan view of the chuck 10, illustrate different views of a representative embodiment in which the coupling means comprises a stem 20 that extends from the rear surface 30 of the specimen plate 15. In such an embodiment, the stem may comprise any suitable component or characteristic. For example, FIG. 1 shows that the stem 20 optionally comprises one or more notches 55 that are adapted to be selectively and releasably captured by jaws (not shown) within the cryostat.

It should be noted that while FIGS. 1 and 3 illustrate a typical embodiment of the chuck 10, the chuck may comprise any known or novel cryostat chuck. In other words, the chuck can be modified in any suitable manner or configured for use with virtually any cryostat. For instance, the size and shape of one chuck adapted for use with one cryostat may be varied, minimally or dramatically, from the size and shape of another chuck that is adapted for use with another cryostat.

Moreover, the chuck may be modified to comprise any additional component that allows the chuck to function as intended. In one example, the rear surface of the chuck comprises one or more heat sink fins (not shown). In this example, the fins may serve any suitable purpose. For example, the fins may provide a surface that can be sprayed with a cold liquid (e.g., liquid nitrogen) to remove heat from the tissue sample and cutting medium during sectioning.

As previously mentioned, in some embodiments, the apparatus and methods for freezing a tissue sample also comprise a tissue heat sink. The tissue heat sink may serve any suitable purpose. In one example, where the chuck is used to freeze the cutting medium and tissue sample, the tissue heat sink is used to speed the freezing process. For instance, the cutting medium and tissue sample may be sandwiched between a pre-chilled chuck and a pre-chilled tissue heat sink. Accordingly, the cutting medium and tissue sample may freeze from two sides, and thereby be frozen faster than would otherwise be possible with the chuck alone. In another example, the heat sink acts as a mold that provides the frozen tissue sample and cutting medium with a flat surface to be sliced by the microtome (not shown).

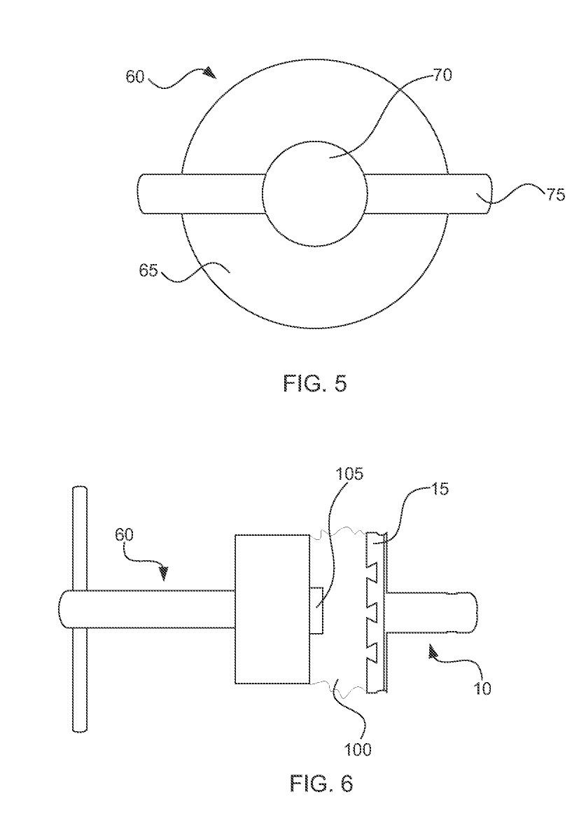

The heat sink may comprise any suitable component that allows it perform its intended purposes. By way of non-limiting example, FIGS. 4 and 5 illustrate different views of a representative embodiment in which the tissue heat sink 60 comprises a heat sink element 65, a heat sink stem 70, and a handle 75.

The various components of the heat sink may perform any suitable function. In one example, the heat sink element is configured to shape and draw heat from the tissue sample and cutting medium. In another example, the heat sink stem and handle attach to the heat sink element in a manner that allows a user to lower the heat sink element onto a tissue sample and cutting medium that are disposed on top of the chuck's specimen plate.

In order to accomplish the aforementioned purposes, the various components of the heat sink may comprise any suitable characteristic. In one example, FIG. 4 shows the heat sink element 65 comprises a substantially planar front surface 80. In still another example, in order to allow the frozen tissue sample and cutting medium to be easily removed from the front planar surface, the planar surface optionally comprises a non-stick coating (e.g., polytetrafluoroethylene, or TEFLON®, as made by DuPont De Nemours).

In addition to, or in place of, the previously described components and characteristics, the heat sink may comprise any other suitable component or characteristic. Indeed, in some embodiments, the heat sink comprises a recess or well into which the tissue sample and/or cutting medium may be placed. In such embodiments, the heat sink acts as a mold as the tissue sample and cutting medium are placed between the heat sink and the chuck. In another example, the heat sink is adapted to connect to the chuck, adjacent to the rear surface of the chuck's specimen plate. In this example, the heat sink is configured to draw heat from the chuck to help the chuck freeze the tissue sample and cutting medium.

The heat sink and chuck may be modified in any suitable manner. In one example, the various parts of the heat sink (and the chuck) are integrally connected to as a single piece. In another example, however, one or more of the components of the heat sink (or chuck) are selectively and releasably coupled together. For instance, the various components of the heat sink (or the chuck) can be threadingly, frictionally, or otherwise mechanically attached so that the heat sink (or chuck) can be disassembled or components of thereof can be interchanged.

The various components of the apparatus for freezing tissue samples may be made of any suitable material. By way of example, at least a portion of chuck and/or the heat sink can be made of a metal having a high specific heat and an ability to readily transfer heat away from the tissue sample and cutting medium. Some non-limiting examples of such metals can comprise copper, a copper alloy, bronze, a bronze alloy, stainless steel, aluminum, and combinations thereof. However, while certain prior art devices employ stainless steel or aluminum, in some preferred embodiments, the chuck and/or heat sink comprise, copper, brass, or alloys thereof. Indeed, because of its relatively high specific heat, its ability to transfer heat, and its ability to bend as it is clamped in the cryostat, in some presently preferred embodiments, the chuck and heat sink comprise copper or a copper alloy.

While the entire chuck and/or heat sink can be made of the same material, in some embodiments, a portion of the chuck or heat sink is made of one material while another portion of the chuck or heat sink is made of another material. In such embodiments, the various components of the chuck and heat sink may be made of any suitable combination of materials. By way of non-limiting example, while the heat sink element is made of a metal with a high specific heat, like copper, the heat sink stem and/or handle can be made of a heat insulating material, such as plastic. Accordingly, a user can touch the handle the heat sink when the heat sink is chilled without being harmed.

In some embodiments, a portion, if not all of, the chuck and/or heat sink is coated with a non-tarnishing coating material. Accordingly, where the chuck or heat sink comprise a material, such as copper, that tarnishes readily, the coating material can prevent the chuck or heat sink from tarnishing and thereby increase the useful life of the freezing apparatus. The non-tarnishing coating material can comprise any material that is capable of preventing the chuck or heat sink from tarnishing. Some non-limiting examples of such materials include tetrafluoroethylene (TEFLON®), stainless steel, chrome, etc. In some presently preferred embodiments, however, the non-tarnishing coating comprises tetrafluoroethylene.

Where the chuck and/or heat sink comprise a non-tarnishing coating, the coating may be placed on any portion of the chuck and/or heat sink. In one example where the chuck or heat sink comprise a tarnishing material, such as copper, and another non-tarnishing material, only the tarnishing material is coated with the non-tarnishing coating. In another example in which the chuck or heat sink comprise both a tarnishing and a non-tarnishing material, the entire chuck or heat sink is coated with the non-tarnishing coating.

Where the chuck and/or the heat sink comprises a non-tarnishing coating, the non-tarnishing coating may have any suitable thickness. For example, the coating may be as thin as about 1/10,000 of an inch or at thick as about 1/50 of an inch. In some preferred embodiments, the non-tarnishing coating is about 1/1,000 of an inch ± 1/500 of an inch.

Where the chuck and/or the heat sink comprise a non-tarnishing coating, the coating may be applied in any suitable manner. For example, the coating may be applied by spraying, dipping, wiping, electroplating, or otherwise depositing the non-tarnishing coating on the chuck or heat sink.

The described apparatus may be used in any suitable manner. By way of non-limiting example, FIG. 6 shows a representative embodiment in which a cutting medium 100 (e.g., polyethylene glycol, polyvinyl alcohol, egg whites, OCT, etc.) is placed on chuck's specimen pate 15.

In order to freeze the cutting medium, the chuck can be cooled in any suitable manner. For example, the chuck can be cooled in the cryostat, in a freezer, with liquid nitrogen, or another suitable method for cooling the chuck to a desired temperature (e.g., between about negative 30 and about negative 20 degrees Celsius). Indeed, in some preferred embodiments, the chuck is chilled within the cryostat before the cutting medium is placed on the chuck.

With the cutting medium in place on the chuck, FIG. 6 further shows that a tissue sample 105 is placed in the cutting medium. Then to increase the rate at which the tissue sample 105 and the cutting medium 100 are frozen, FIG. 6 shows that the heat sink 60 is placed in contact with the tissue sample 105 and/or cutting medium 100, opposite to the chuck 10.

Once the tissue sample and cutting medium are frozen, the heat sink is removed from the tissue sample and cutting medium. At that point, the chuck, which has the tissue sample and the cutting medium secured thereto, is mounted in the cryostat so that the tissue sample can be sectioned and mounted on microscope slides.

The described apparatus and methods for freezing tissue samples offer several beneficial characteristics. For example, where the chuck and heat sink comprise a metal, such as copper, that has a high specific heat, the described apparatus can freeze a tissue sample and cutting medium much faster than would be possible with certain conventional tissue holders and heat sinks. For instance, in comparison with conventional holding elements comprising stainless steel or aluminum, the described chuck and heat sink can reduce tissue sample and cutting medium freezing time by about 3 minutes.

In another example, where the chuck comprises one or more dovetail-shaped apertures, the chuck may maintain the spatial relationship of the tissue sample during sectioning better than some conventional tissue holders. Accordingly, the described chuck may allow a user to obtain more accurate results than could be possible with certain conventional tissue holders.

In still another example, where the chuck and/or the heat sink comprise a non-tarnishing coating material, the chuck or heat sink can comprise tarnishing materials without tarnishing. Thus, the described apparatus can have the desired characteristics of tarnishing materials, such as copper, while having the useful life of an apparatus made from a non-tarnishing material.

While specific embodiments and examples of the present invention have been illustrated and described, numerous modifications come to mind without significantly departing from the spirit of the invention, and the scope of protection is only limited by the scope of the accompanying claims.

1. An apparatus for freezing tissue samples for sectioning, comprising:
a cryostat chuck, comprising a specimen plate having a dovetail-shaped aperture disposed in a first surface of the plate,
wherein the cryostat chuck comprises a material selected from the group consisting of copper, a copper alloy, brass, a brass alloy, and combinations thereof, and
wherein the first surface of the specimen plate comprises a non-tarnishing coating material.

2. The apparatus of claim 1, wherein the dovetail-shaped aperture comprises a dovetail-shaped groove.

3. The apparatus of claim 1, wherein the non-tarnishing coating material comprises a material selected from stainless steel, chrome, and tetrafluoroethylene.

4. The apparatus of claim 1, wherein the non-tarnishing coating material comprises polytetrafluoroethylene.

5. The apparatus of claim 1, wherein the cryostat chuck comprises copper.

6. The apparatus of claim 1, wherein the cryostat chuck comprises copper and the non-tarnishing coating material comprises polytetrafluoroethylene.

7. The apparatus of claim 1, wherein:
the cryostat chuck comprises copper,
the non-tarnishing coating material comprises tetrafluoroethylene, and
the dovetail-shaped aperture comprises a dovetail-shaped groove.

8. The apparatus of claim 1, further comprising a heat sink, wherein the heat sink comprises:
a material selected from copper, a copper alloy, brass, and a brass alloy, and
a non-tarnishing coating material.

9. The apparatus of claim 8, wherein the heat sink comprises copper.

10. The apparatus of claim 8, wherein the non-tarnishing material comprises tetrafluoroethylene.

11. The apparatus of claim 10, wherein the heat sink comprises copper and the non-tarnishing material comprises tetrafluoroethylene.

12. An apparatus for freezing tissue samples for sectioning, comprising:
a cryostat chuck, comprising:
a specimen plate having a dovetail-shaped groove disposed in a first surface of the plate,
wherein the cryostat chuck comprises copper, and
wherein the first surface of the specimen plate comprises a polytetrafluoroethylene coating.

13. The apparatus of claim 12, further comprising a heat sink comprising copper and having a tetrafluoroethylene coating.
